(19) United States
(12) Patent Application Publication
(10) Pub. No.: US 2016/0053094 A1
(43) Pub. Date: Feb. 25, 2016

(54) Rubber Composition for Heavy-Load Pneumatic Tire

(71) Applicant: THE YOKOHAMA RUBBER CO., LTD., Tokyo (JP)

(72) Inventors: Mizuki Takeuchi, Hiratsuka-shi, Kanagawa (JP); Ayako Kamahori, Hiratsuka-shi, Kanagawa (JP); Satoshi Mihara, Hiratsuka-shi, Kanagawa (JP); Rinko Kushida, Hiratsuka-shi, Kanagawa (JP); Koichiro Miyoshi, Hiratsuka-shi, Kanagawa (JP)

(21) Appl. No.: 14/781,154

(22) PCT Filed: Mar. 31, 2014
(86) PCT No.: PCT/JP2014/059545

§ 371 Date: Sep. 29, 2015

(30) Foreign Application Priority Data
Mar. 29, 2013 (JP) 2013-071499

(51) Int. Cl. C08L 7/00; C08K 5/548; C08K 5/44; C08K 3/04; C08K 3/36

(52) U.S. Cl. CPC C08L 7/00; C08K 3/04; C08K 3/36; C08K 5/44; C08K 5/548; C08K 2003/045

(57) ABSTRACT

The rubber composition of the present technology comprises: from 35 to 50 parts by weight of silica, from 1.5 to 3.5 parts by weight of sulfur, carbon black, a sulfenamide vulcanization accelerator, and a sulfur-containing silane coupling agent per 100 parts by weight of a diene rubber containing from 80 to 100 wt. % of a natural rubber; a total amount of the sulfur and the sulfur in the sulfur-containing silane coupling agent being from 1.85 to 6.0 parts by weight; and a compounded amount of the sulfenamide vulcanization accelerator being from A parts by weight to 2.6 parts by weight both inclusive, where A is determined by the formula A=0.2209S²−1.409S+1.309Y+2.579, where S is the compounded amount of the sulfur and Y is a positive number.

### TECHNICAL FIELD

The present technology relates to a rubber composition for a heavy-load pneumatic tire by which low rolling resistance, wear resistance, and uneven wear resistance are enhanced.

### BACKGROUND

In recent years, there has been an emphasis on reducing the environmental burden of heavy-load pneumatic tires, as seen in the labeling systems of Japan and Europe and the SmartWay regulations of North America, and there is a demand to improve fuel consumption performance by reducing rolling resistance, in particular. As an indicator of the rolling resistance of a rubber composition, tan δ at 60° C. determined by dynamic visco-elasticity measurement is typically used, wherein a smaller value of tan δ (60° C.) of the rubber composition indicates smaller rolling resistance.

Examples of methods of reducing the tan δ (60° C.) of a rubber composition include reducing the compounded amount of carbon black and increasing the particle size of carbon black. However, such methods are problematic in that the mechanical properties such as tensile strength at break, tensile elongation at break, and rubber hardness are diminished and that the wear resistance and uneven wear resistance are diminished when a heavy-load pneumatic tire is produced.

International Patent Publication No. WO/2010/077232 proposes to compound silica, carbon black, a silane coupling agent, sulfur, and a sulfenamide accelerator at specific proportions with natural rubber in order to reduce the rolling resistance of tires for large vehicles. However, with this rubber composition, the effect of reducing rolling resistance is not always sufficient. In addition, the tire durability, as indicated by wear resistance, uneven wear resistance, and the like is also insufficient. That is, there has been a demand for further improvements in rubber compositions for a heavy-load pneumatic tire in order to enhance the low rolling resistance, wear resistance, and uneven wear resistance to or beyond conventional levels.

### SUMMARY

The present technology provides a rubber composition for a heavy-load pneumatic tire by which low rolling resistance, wear resistance, and uneven wear resistance are enhanced to or beyond conventional levels.

A rubber composition for a heavy-load pneumatic tire of the present technology which achieves the object described above is a rubber composition comprising: from 35 to 50 parts by weight of silica, from 1.5 to 3.5 parts by weight of sulfur, carbon black, a sulfenamide vulcanization accelerator, and a sulfur-containing silane coupling agent per 100 parts by weight of a diene rubber containing from 80 to 100 wt. % of a natural rubber and from 20 to 0 wt. % of an isoprene rubber; a total amount of the sulfur and the sulfur in the sulfur-containing silane coupling agent being from 1.85 to 6.0 parts by weight; and a compounded amount of the sulfenamide vulcanization accelerator being from A parts by weight to 2.6 parts by weight both inclusive, where A is determined by the following formula (1):

A=0.2209S²−1.409S+1.309Y+2.579 (1)

where in formula (1), A is a lower limit of the compounded amount (parts by weight) of the sulfenamide vulcanization accelerator, S is the compounded amount (parts by weight) of the sulfur, and Y is a positive number determined by Y=Ws/(Ws+Wc), where Ws is a compounded amount (parts by weight) of the silica, and Wc is a compounded amount (parts by weight) of the carbon black.

The rubber composition for a heavy-load pneumatic tire of the present technology is prepared by blending carbon black, silica, sulfur, a sulfenamide vulcanization accelerator, and a sulfur-containing silane coupling agent with a diene rubber containing a natural rubber as a main component, wherein the total amount of the sulfur and the sulfur in the sulfur-containing silane coupling agent is limited, and the compounded amount of the sulfenamide vulcanization accelerator is further specified, so it is possible to enhance the wear resistance and uneven wear resistance to or beyond conventional levels while reducing the rolling resistance when the composition is used to produce a tire.

In addition, the carbon black is ISAF grade or SAF grade, and it is preferable for the compounded amount Wc of the carbon black and the compounded amount Ws of the silica to satisfy the relation of the following formula (2) so that the rubber composition can effect reduced heat build-up.

Wc≦32.71−0.592Ws (2)

(where in formula (2), Ws is the compounded amount (parts by weight) of silica, and Wc is the compounded amount (parts by weight) of carbon black.)

The heavy-load pneumatic tire of the present technology comprises a tread cap formed from the rubber composition for a heavy-load pneumatic tire described above. This heavy-load pneumatic tire can enhance fuel consumption performance while reducing the rolling resistance. In addition, since the wear resistance and uneven wear resistance are simultaneously enhanced to or beyond conventional levels, the tire durability is also enhanced.

Further, in the heavy-load pneumatic tire, an undertread is preferably formed from a rubber composition for an undertread containing from 15 to 45 parts by weight of carbon black and from 3 to 30 parts by weight of silica per 100 parts by weight of a diene rubber comprising from 70 to 90 wt. % of a natural rubber and/or an isoprene rubber and from 30 to 10 wt. % of a butadiene rubber and/or a styrene-butadiene rubber, and containing a silane coupling agent in an amount of from 5 to 15 wt. % of the amount of the silica, and a nitrogen adsorption specific surface area N₂SA of the carbon black is from 35 to 85 m²/g, and a DBP (dibutyl phthalate) absorption number is from 110 to 200 ml/100 g. This heavy-load pneumatic tire is able to further reduce the rolling resistance, to enhance the wear resistance and uneven wear resistance, and to further increase the tire durability.

### BRIEF DESCRIPTION OF THE DRAWING(S)

FIG. 1 is a cross-sectional view in the meridian direction illustrating an example of an embodiment of a heavy-load pneumatic tire of the present technology.

### DETAILED DESCRIPTION

In the present specification, a heavy-load pneumatic tire refers to a large pneumatic tire mounted on a truck, bus, or construction vehicle.

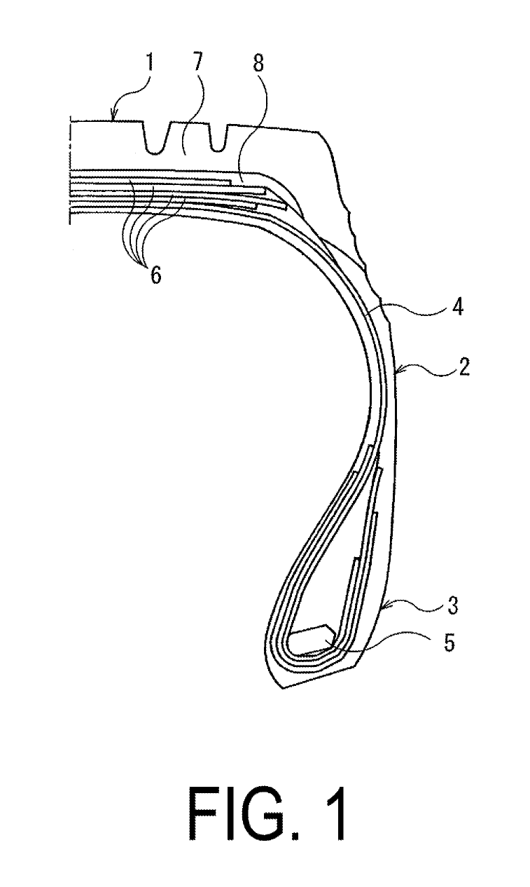

In FIG. 1, a heavy-load pneumatic tire comprises a tread portion 1, a sidewall portion 2, and a bead portion 3. A carcass layer 4 is mounted between the left and right bead portions 3 and 3, and each end of the carcass layer 4 is folded over from the inside to the outside of the tire around a bead core 5. A belt layer 6 with a four-layer structure is disposed on the outer side in the tire radial direction of the carcass layer 4 in the tread portion 1, and a tread rubber is disposed on the outside of the belt layer 6 on the outermost side. The tread rubber has a two-layer structure comprising an undertread rubber layer 8 on the inner side in the radial direction adjacent to the belt layer 6, and a tread cap rubber layer 7 on the outer side in the radial direction exposed to the surface of the tread portion 1.

The rubber composition for a heavy-load pneumatic tire of the present technology is suitable for forming the tread portion 1 and specifically the tread cap portion—that is, the tread cap rubber layer 7—of the heavy-load pneumatic tire. Therefore, the rubber composition for a heavy-load pneumatic tire of the present technology may also be called a “rubber composition for a tread cap”. In addition, in contrast to this, the rubber composition constituting the undertread rubber layer 8 of the tread portion is sometimes called a “rubber composition for an undertread”.

In the rubber composition for a heavy-load pneumatic tire of the present technology, the rubber component is a diene rubber comprising a natural rubber or a natural rubber and an isoprene rubber. Since the diene rubber is composed of a natural rubber and an isoprene rubber, the wear resistance and uneven wear resistance of the rubber composition can be ensured at high levels.

The content of natural rubber in 100 wt. % of the diene rubber is from 80 to 100 wt. %, and preferably from 90 to 100 wt. %. When the content of the natural rubber is less than 80 wt. % there is a risk that it may not be possible to sufficiently enhance the wear resistance and uneven wear resistance. The content of isoprene rubber in 100 wt. % of the diene rubber is from 20 to 0 wt. %, and preferably from 10 to 0 wt. %. When the content of the isoprene rubber exceeds 20 wt. %, there is a risk that it may not be possible to sufficiently enhance the wear resistance and uneven wear resistance.

In the rubber composition for a heavy-load pneumatic tire of the present technology, the diene rubber comprises 100 wt. % of a natural rubber or 100 wt. % of the total of a natural rubber and an isoprene rubber. When various compounding agents are added to the rubber composition for a heavy-load pneumatic tire and another diene rubber other than natural rubber and isoprene rubber is contained as a diluting material or a base rubber of a master batch, the use of such compounding agents is not excluded, and such compounding agents may be used within a range that does not impair the object of the present technology. Examples of other diene rubbers include butadiene rubber, styrene-butadiene rubber, and acrylonitrile-butadiene rubber.

In the present technology, silica is compounded at from 35 to 50 parts by weight, preferably from 35 to 47 parts by weight, and more preferably from 36 to 45 parts by weight per 100 parts by weight of the diene rubber. By adding silica, it is possible to reduce the rolling resistance when the composition is used to produce a tire. When the compounded amount of silica is less than 35 parts by weight, the rolling resistance becomes large. When the compounded amount of silica exceeds 50 parts by weight, the wear resistance and uneven wear resistance are diminished.

The nitrogen adsorption specific surface area of silica is not particularly limited; however, the nitrogen adsorption specific surface area is preferably from 150 to 300 m²/g, and more preferably from 160 to 240 m²/g. When the nitrogen adsorption specific surface area of silica is less than 150 m²/g, the wear resistance and uneven wear resistance are diminished, which is not preferable. In addition, when the nitrogen adsorption specific surface area of silica exceeds 300 m²/g, the rolling resistance becomes large, which is not preferable. Note that the nitrogen adsorption specific surface area of the silica is determined in accordance with JIS (Japanese Industrial Standard) K6217-2.

The silica that is used may be a silica that is ordinarily used in rubber compositions for tires such as, for example, wet silica, dry silica, surface-treated silica, or the like. The silica to be used may be appropriately selected from commercially available products. Additionally, a silica obtained through a regular manufacturing method may be used.

The rubber composition for a heavy-load pneumatic tire of the present technology contains carbon black. By compounding carbon black, it is possible to increase the strength of the rubber composition and to thereby increase the wear resistance and uneven wear resistance. The grade of the carbon black that is used, which is classified by ASTM (American Society for Testing and Materials) D1765, is preferably ISAF (Intermediate Super-Abrasion Furnace) grade or SAF (Super-Abrasion Furnace) grade, which makes it possible to increase the wear resistance and uneven wear resistance of the rubber composition.

Carbon black is compounded in an amount of preferably at least 3 parts by weight and more preferably at least 7 parts by weight per 100 parts by weight of the diene rubber. When the compounded amount of the carbon black is less than 3 parts by weight, the rubber strength, wear resistance, and uneven wear resistance of the rubber composition are diminished. The upper limit of the compounded amount of the carbon black is preferably determined by the relationship with the compounded amount of silica. That is, when the compounded amount of silica is defined as Ws (parts by weight) and the compounded amount of carbon black is defined as Wc (parts by weight), the relationship between Ws and Wc preferably satisfies the following formula (2).

Wc≦32.71−0.592 Ws (2)

(In formula (2), Ws is the compounded amount (parts by weight) of silica, and Wc is the compounded amount (parts by weight) of carbon black.)

When the compounded amount Wc of carbon black exceeds the value of the right-hand side of formula (2), the rolling resistance becomes large, and the wear resistance and uneven wear resistance are actually diminished.

The carbon black used in the rubber composition for a tread cap of the present technology is preferably ISAF grade or SAF grade, and the nitrogen adsorption specific surface area is preferably from 100 to 150 m²/g and more preferably from 110 to 125 m²/g. When the nitrogen adsorption specific surface area is less than 100 m²/g, the mechanical properties such as the rubber strength of the rubber composition are reduced, and the wear resistance and uneven wear resistance are diminished. When the nitrogen adsorption specific surface area exceeds 150 m²/g, the rolling resistance becomes large. The nitrogen adsorption specific surface area of the carbon black is measured in accordance with JIS K6217-2.

In the rubber composition for a tread cap, the total amount of carbon black and silica is preferably from 38 to 53 parts by weight and more preferably from 42 to 50 parts by weight per 100 parts by weight of the diene rubber. When the total amount of carbon black and silica is less than 38 parts by weight, the wear resistance and uneven wear resistance are diminished. In addition, when the total amount of carbon black and silica exceeds 53 parts by weight, the rolling resistance becomes large.

The rubber composition for a heavy-load pneumatic tire of the present technology contains a sulfur-containing silane coupling agent as well as silica. By compounding the sulfur-containing silane coupling agent, it is possible to enhance the dispersibility of the silica, to further reduce the low heat build-up of the rubber composition, to further reduce the rolling resistance, and to enhance the wear resistance and uneven wear resistance.

The sulfur-containing silane coupling agent is not particularly limited; however, examples thereof include bis-(3-triethoxysilylpropyl)tetrasulfide, bis(3-(triethoxysilyl)propyl)disulfide, 3-trimethoxysilylpropylbenzothiazol tetrasulfide, γ-mercaptopropyltriethoxysilane, 3-octanoylthiopropyltriethoxysilane, and the like. Of these, bis-(3-triethoxysilylpropyl)tetrasulfide and bis(3-(triethoxysilyl)propyl)disulfide are preferable.

In the present technology, the total amount of the sulfur contained in the sulfur-containing silane coupling agent and the sulfur that is compounded for vulcanization must be in a range of from 1.85 to 6.0 parts by weight per 100 parts by weight of the diene rubber. The compounded amount of the sulfur-containing silane coupling agent is not particularly limited as long as the total amount of sulfur of the sulfur-containing silane coupling agent and the sulfur for vulcanization is within the range described above; however, the compounded amount is preferably from 5 to 20 wt. %, and more preferably from 8 to 14 wt. %, relative to the compounded amount of silica. When the compounded amount of the sulfur-containing silane coupling agent is less than 5 wt. % of the amount of silica, the effect of enhancing the dispersibility of the silica cannot be sufficiently obtained. When the compounded amount of the sulfur-containing silane coupling agent is greater than 20 wt. % of the amount of silica, the silane coupling agent will condense with itself, and the desired effects cannot be obtained.

In the present technology, other fillers aside from carbon black and silica may be compounded. Examples of other fillers include clay, mica, talc, calcium carbonate, aluminum hydroxide, aluminum oxide, titanium oxide, and the like. Of these, calcium carbonate, clay, and aluminum oxide are preferable. By compounding other fillers, mechanical properties of the rubber composition can be further enhanced, and a balance between low heat build-up, cut resistance, and processability when the rubber composition is formed into a tire can be enhanced.

The rubber composition for a heavy-load pneumatic tire of the present technology contains from 1.5 to 3.5 parts by weight and preferably from 2.0 to 3.0 parts by weight of sulfur as a vulcanization agent per 100 parts by weight of the diene rubber. When the compounded amount of sulfur is less than 1.5 parts by weight, the uneven wear resistance and rolling resistance are diminished. In addition, when the compounded amount of sulfur exceeds 3.5 parts by weight, the wear resistance and durability are diminished.

In the present technology, the total amount of the sulfur and the sulfur in the sulfur-containing silane coupling agent is from 1.85 to 6.0 parts by weight and preferably from 2.5 to 4.0 parts by weight per 100 parts by weight of the diene rubber. Here, the “total amount of sulfur” is a total of the net amount of sulfur contained in the vulcanizing agent and the net amount of sulfur contained in the sulfur-containing silane coupling agent; and is the amount of sulfur used in vulcanization. For example, when the vulcanizing agent contains sulfur and oil, the “total amount of sulfur” refers to the net amount of sulfur excluding the amount of oil. When the total amount of the sulfur and the sulfur in the sulfur-containing silane coupling agent is less than 1.85 parts by weight, the uneven wear resistance and rolling resistance are diminished. In addition, when the total amount of the sulfur and the sulfur in the sulfur-containing silane coupling agent exceeds 6.0 parts by weight, the wear resistance and durability are diminished.

The rubber composition for a heavy-load pneumatic tire of the present technology contains a sulfenamide vulcanization accelerator. The lower limit of the compounded amount of the sulfenamide vulcanization accelerator with respect to 100 parts by weight of the diene rubber is A parts by weight, where A is determined by the following formula (1), and the upper limit is 2.6 parts by weight and preferably 2.0 parts by weight.

A=0.2209S²−1.409S+1.309Y+2.579 (1)

(In formula (1), A is the lower limit of the compounded amount (parts by weight) of the sulfenamide vulcanization accelerator; S is the compounded amount (parts by weight) of sulfur; Y is a positive number determined by Y=Ws/(Ws+Wc), Ws is the compounded amount (parts by weight) of silica; and Wc is the compounded amount (parts by weight) of carbon black.)

The lower limit of the compounded amount of the sulfenamide vulcanization accelerator is preferably B parts by weight, where B is determined by the following formula (3).

B=0.2209S²−1.409S+1.309Y+2.639 (3)

(In formula (3), B is a suitable lower limit of the compounded amount (parts by weight) of the sulfenamide vulcanization accelerator; S is the compounded amount (parts by weight) of sulfur; Y is a positive number determined by Y=Ws/(Ws+Wc), Ws is the compounded amount (parts by weight) of silica; and Wc is the compounded amount (parts by weight) of carbon black.)

When the compounded amount of the sulfenamide vulcanization accelerator is less than A parts by weight determined by formula (1), the uneven wear resistance and rolling resistance are diminished. In addition, when the compounded amount of the sulfenamide vulcanization accelerator exceeds 2.6 parts by weight, the wear resistance and durability are diminished.

Examples of sulfenamide vulcanization accelerators include N-cyclohexyl-2-benzothiazolylsulfenamide, N-tert-butyl-2-benzothiazolylsulfenamide, N-oxydiethylene-2-benzothiazolylsulfenamide, N,N-dicyclohexyl-2-benzothiazolylsulfenamide, N,N-diisopropyl-2-benzothiazolylsulfenamide, and 2-(morpholinodithio)benzothiazole.

The rubber composition for a heavy-load pneumatic tire of the present technology may contain a guanidine vulcanization accelerator. The compounded amount of the guanidine vulcanization accelerator is preferably from 0.1 to 1.0 parts by weight and more preferably from 0.1 to 0.6 parts by weight per 100 parts by weight of the diene rubber. When the compounded amount of the guanidine vulcanization accelerator is less than 0.1 parts by weight, there is a risk that the uneven wear resistance and rolling resistance may be diminished. In addition, when the compounded amount of the guanidine vulcanization accelerator exceeds 1.0 parts by weight, there is a risk that the wear resistance and durability may be diminished.

Examples of guanidine vulcanization accelerators include 1,3-diphenylguanidine, 1,3-di-o-tolyguanidine, and 1-(o-tolyl)biguanide.

The rubber composition for a heavy-load pneumatic tire of the present technology preferably contains a master batch containing aramid pulp. By compounding a master batch containing aramid pulp, it is possible to further enhance the uneven wear resistance and to further reduce the rolling resistance while ensuring wear resistance. Here, “aramid pulp” is an organic filler prepared by fibrillating aramid fiber filaments. A commercially available product may be used as the master batch of the aramid pulp, examples of which are Twaron D3500 and Sulflon D3515 available from Teijin, Ltd.

The compounded amount of the aramid pulp master batch is preferably from 0.5 to 5.0 parts by weight and more preferably from 1.0 to 3.0 parts by weight in terms of the net amount of aramid pulp per 100 parts by weight of the diene rubber. When the net compounded amount of the aramid pulp is less than 0.5 parts by weight, the effects of compounding the aramid pulp master batch cannot be sufficiently achieved. When the net compounded amount of the aramid pulp exceeds 5.0 parts by weight, there is a risk that the wear resistance may be diminished.

The heavy-load pneumatic tire of the present technology comprises a tread portion—specifically, a tread cap portion—formed from the rubber composition for a heavy-load pneumatic tire described above. This heavy-load pneumatic tire can enhance fuel consumption performance while reducing the rolling resistance. In addition, since the wear resistance and uneven wear resistance are simultaneously enhanced to or beyond conventional levels, the tire durability is also enhanced.

In the heavy-load pneumatic tire of the present technology, the tread cap portion is preferably formed from the rubber composition for a heavy-load pneumatic tire described above (rubber composition for a tread cap), and the undertread portion is preferably formed from a rubber composition for an undertread described below. This heavy-load pneumatic tire can dramatically enhance the low rolling resistance, wear resistance, and uneven wear resistance as well as improve the tire durability.

The rubber composition for an undertread that is suitably used in the present technology contains from 15 to 45 parts by weight of carbon black and from 3 to 30 parts by weight of silica per 100 parts by weight of a diene rubber comprising from 70 to 100 wt. % of a natural rubber and/or an isoprene rubber and from 30 to 0 wt. % of a butadiene rubber and /or a styrene-butadiene rubber, and contains a silane coupling agent in an amount of from 5 to 15 wt. % of the amount of silica, and the nitrogen adsorption specific surface area N₂SA of the carbon black is from 35 to 85 m²/g, and the DBP absorption number is from 110 to 200 ml/100 g. This rubber composition for an undertread ensures the rubber hardness and makes it possible to reduce tan δ (60° C.) so as to maintain/enhance the durability while reducing the rolling resistance when the composition is used to produce a tire.

In the rubber composition for an undertread, the diene rubber contains natural rubber and/or isoprene rubber, and butadiene rubber and/or styrene-butadiene rubber, preferably butadiene rubber. By compounding the natural rubber and isoprene rubber as main components together with the butadiene rubber and styrene-butadiene rubber and specific carbon black and silica, the heat build-up of the rubber composition for an undertread can be made small, and the tire durability can be enhanced by improving mechanical properties such as rubber hardness, tensile strength at break, and tensile elongation at break.

The compounded amount of the natural rubber and/or isoprene rubber in 100 wt. % of the diene rubber is from 70 to 100 wt. %, and preferably from 80 to 90 wt. %. When the compounded amount of the natural rubber and the isoprene rubber is less than 70 wt. %, the tensile strength at break and tensile elongation at break of the rubber composition for an undertread are diminished. Furthermore, durability will be decreased when a tire is produced.

The compounded amount of the butadiene rubber and/or styrene-butadiene rubber in 100 wt. % of the diene rubber is from 30 to 0 wt. %, and preferably from 20 to 10 wt. %. When the compounded amount of the butadiene rubber and the styrene-butadiene rubber exceeds 30 wt. %, the tensile strength at break and tensile elongation at break of the rubber composition for an undertread is diminished, and the durability when the composition is used to produce a tire is thereby diminished.

The diene rubber in the rubber composition for an undertread more preferably comprises from 80 to 100 wt. % of a natural rubber and/or an isoprene rubber and from 20 to 0 wt. % of a butadiene rubber.

In the rubber composition for an undertread, the silica and the carbon black must be compounded. As described above, by compounding specific carbon black and silica together with the butadiene rubber and/or styrene-butadiene rubber, the heat build-up of the rubber composition for an undertread can be made small, and the tire durability can be enhanced by improving mechanical properties such as rubber hardness, tensile strength at break, and tensile elongation at break.

In the rubber composition for an undertread, using a high-structured carbon black having a large particle size makes it possible to avoid diminishing the mechanical properties such as the rubber hardness, tensile strength at break, and tensile elongation at break while making the tan δ (60° C.) of the rubber composition for an undertread small.

The carbon black used in the rubber composition for an undertread has a nitrogen specific surface area N₂SA of from 35 to 85 m²/g, preferably from 40 to 80 m²/g, and more preferably from 40 to 70 m²/g. When N₂SA is less than 35 m²/g, the mechanical properties such as the rubber hardness, tensile strength at break, and wear resistance of the rubber composition for an undertread are diminished. When the N₂SA exceeds 85 m²/g, tan δ (60° C.) increases thereby increasing heat build-up. The nitrogen adsorption specific surface area N₂SA is measured in accordance with JIS K6217-2.

Furthermore, a DBP absorption number of the carbon black is from 110 to 200 mL/100 g, preferably from 135 to 190 mL/100 g, and more preferably from 151 to 180 mL/100 g. When the DBP absorption number is less than 110 mL/100 g, reinforcing performance of the carbon black cannot be sufficiently obtained, and the tire durability decreases. When the DBP absorption number exceeds 200 ml/100 g, the mechanical properties such as the tensile elongation at break of the rubber composition for an undertread are diminished, and the tire durability is thereby diminished. Furthermore, processability deteriorates due to an increase in viscosity. The DBP absorption number is measured in accordance with JIS K6217-4, Oil Absorption Number Method A.

The compounded amount of the carbon black is from 15 to 45 parts by weight, preferably from 20 to 40 parts by weight, and more preferably from 25 to 40 parts by weight, per 100 parts by weight of the diene rubber. When the compounded amount of the carbon black is less than 15 parts by weight, the reinforcing performance with respect to the rubber composition for an undertread cannot be sufficiently achieved, and the rubber hardness and tensile strength at break are insufficient. When the compounded amount of the carbon black exceeds 45 parts by weight, the heat build-up of the rubber composition for an undertread increases while the tensile elongation at break decreases.

The compounded amount of the silica is from 3 to 30 parts by weight, preferably from 5 to 25 parts by weight, and more preferably from 7 to 23 parts by weight, per 100 parts by weight of the diene rubber. By setting the compounded amount of the silica in such a range, both low rolling resistance and durability can be achieved when a tire is produced. When the compounded amount of the silica is less than 3 parts by weight, heat build-up becomes large and rolling resistance, when a tire is produced, cannot be sufficiently made small. Furthermore, tensile strength at break decreases. When the compounded amount of the silica exceeds 30 parts by weight, tensile strength at break decreases thereby decreasing tire durability.

The total compounded amount of the silica and the carbon black is preferably from 20 to 75 parts by weight, and more preferably from 25 to 70 parts by weight, per 100 parts by weight of the diene rubber. By setting the total amount of the silica and the carbon black within such a range, low rolling resistance and durability of the rubber composition for the undertread can be balanced to a higher level. When the total amount of the silica and the carbon black is less than 20 parts by weight, tire durability cannot be ensured. When the total amount of the silica and the carbon black exceeds 75 parts by weight, heat build-up increases thereby deteriorating rolling resistance.

In the rubber composition for an undertread, a silane coupling agent is blended together with the silica so as to improve the dispersibility of the silica and to further increase the reinforcement properties with rubber components. The compounded amount of the silane coupling agent is from 5 to 15 wt. %, and preferably from 7 to 13 wt. %, relative to the amount of silica. When the compounded amount of the silane coupling agent is less than 5 wt. % of the silica weight, the effect of improving the dispersion of the silica cannot be sufficiently obtained. Furthermore, when the compounded amount of the silane coupling agent exceeds 15 wt. %, the silane coupling agents condense with each other, and the desired effects cannot be obtained.

The rubber composition for a heavy-load pneumatic tire may also contain various types of additives that are commonly used in rubber compositions for tires, such as vulcanization or crosslinking agents, vulcanization accelerators, and antiaging agents, in a range that does not impair the object of the present technology. These additives may be kneaded according to any common method to form the rubber composition and may be used in vulcanization or crosslinking. The compounded amount of these additives may be any conventional amount, as long as the object of the present technology is not impaired. The rubber composition for a heavy-load pneumatic tire of the present technology can be produced by mixing each of the components described above using a commonly used rubber kneading machine, such as a Banbury mixer, a kneader, and a roller.

The present technology is further explained below by examples. However, the scope of the present technology is not limited to these examples.

### EXAMPLES

Eighteen types of rubber compositions for a heavy-load pneumatic tire containing the compounding agents described in Table 3 as a shared formulation and the formulations described in Tables 1 and 2 (Working Examples 1 to 7 and Comparative Examples 1 to 11) were prepared by kneading the components excluding sulfur and the vulcanization accelerator in a 1.8 L sealed mixer for 5 minutes at 160° C., extruding the mixture as a master batch, adding sulfur and the vulcanization accelerator to the master batch, and then kneading the master batch with an open roller. The total amount of sulfur in the sulfur and the sulfur-containing silane coupling agent is described in the “total sulfur content” rows of Table 1 and 2. The added amounts of the shared compounding agents described in Table 3 are expressed in parts by weight per 100 parts by weight of the diene rubbers (100 parts by weight of the net amount of rubber) described in Tables 1 and 2.

The obtained eighteen types of rubber compositions for a heavy-load pneumatic tire were used in tread cap portions, heavy-load pneumatic tires were vulcanization molded, and the obtained heavy-load pneumatic tires were used to test the wear resistance, uneven wear resistance, and rolling resistance with the following methods.

### Wear Resistance

Pneumatic tires with a tire size of 275/80R22.5 were vulcanization molded, and the resulting tires were assembled on a standard rim (wheel with a size of 22.5×7.5), filled with 900 kPa of air pressure, and mounted on the same type of truck. The truck was repeatedly made to travel over a certain interval in which the ratio of general roads to highways was 10:90, and when the truck had traveled the same distance for each tire, the groove depth (remaining groove) of each main groove was measured. The obtained results are shown in the “Wear resistance” rows as an index with the value of Comparative Example 1 being defined as 100. Larger index values of wear resistance indicate better wear resistance and better tire durability.

### Uneven Wear Resistance

Pneumatic tires with a tire size of 295/80R22.5 were vulcanization molded, and the resulting tires were assembled on a standard rim (wheel with a size of 22.5×8.25), filled with 900 kPa of air pressure, and mounted on the front axle of a tractor head. The vehicle was made to travel 50,000 km in a state in which a load of 3,650 kg was applied to each tire. The inflation profile prior to this traveling test and the inflation profile after this traveling test were compared, and the value of “(amount of wear of shoulder edge)−(amount of wear of outer main groove)” was measured and used as the amount of shoulder drop wear (amount of uneven wear). The obtained results are shown in the “Uneven wear resistance” rows as an index with the inverse of the value of Comparative Example 1 being defined as 100. Larger index values of uneven wear resistance indicate better uneven wear resistance and better tire durability.

### Rolling Resistance

Pneumatic tires having a tire size of 275/80R22.5 were vulcanization molded, and the obtained tires were assembled on a standard rim (wheel with a size of 22.5×7.5), and mounted on an indoor drum testing machine (drum diameter: 1,707 mm) in accordance with JIS D4230. The rolling resistance was determined by measuring the resistance at a speed of 80 km/hr at an air pressure of 900 kPa and under a load of 33.8 kN. The obtained results are shown in the “Rolling resistance” rows of Tables 1 and 2 as an index with the value of Comparative Example 1 being defined as 100. Smaller index values indicate lower rolling resistance and superior fuel consumption performance.

TABLE 1

| | | Comparative | Comparative | Working | Comparative | Comparative |
|---|---|---|---|---|---|---|
| | | Example 1 | Example 2 | Example 1 | Example 3 | Example 4 |
| NR | pbw | 100 | 100 | 100 | 100 | 100 |
| Carbon black | pbw | 8 | 8 | 8 | 8 | 0 |
| 1 (Wc) | | | | | | |
| Silica (Ws) | pbw | 40 | 40 | 40 | 40 | 55 |
| Coupling | pbw | 4.0 | 4.0 | 4.0 | 4.0 | 5.5 |
| agent | | | | | | |
| Sulfur (S) | pbw | 2.3 | 1.4 | 2.3 | 3.6 | 2.3 |
| Vulcanization | pbw | 1.40 | 2.10 | 1.65 | 1.45 | 1.90 |
| accelerator | | | | | | |
| Total sulfur | pbw | 3.09 | 2.23 | 3.09 | 4.33 | 3.43 |
| content | | | | | | |
| Y-value of | — | 0.83 | 0.83 | 0.83 | 0.83 | 1.00 |
| formula (1) | | | | | | |
| A-value of | — | 1.60 | 2.13 | 1.60 | 1.46 | 1.82 |
| formula (1) | | | | | | |
| Value of the | — | 9.0 | 9.0 | 9.0 | 9.0 | 0.2 |
| right-hand side | | | | | | |
| of formula (2) | | | | | | |
| Wear | Index | 100 | 98 | 101 | 97 | 94 |
| resistance | value | | | | | |
| Uneven wear | Index | 100 | 96 | 105 | 96 | 104 |
| resistance | value | | | | | |
| Rolling | Index | 100 | 103 | 95 | 105 | 90 |
| resistance | value | | | | | |

| | | Working | Comparative | Comparative | Comparative |
|---|---|---|---|---|---|
| | | Example 2 | Example 5 | Example 6 | Example 7 |
| NR | pbw | 100 | 100 | 100 | 100 |
| Carbon black | pbw | 5 | 20 | 8 | 8 |
| 1 (Wc) | | | | | |
| Silica (Ws) | pbw | 45 | 25 | 40 | 40 |
| Coupling | pbw | 4.5 | 2.5 | 4.0 | 4.0 |
| agent | | | | | |
| Sulfur (S) | pbw | 2.3 | 2.3 | 0.9 | 5.4 |
| Vulcanization | pbw | 1.75 | 1.4 | 2.6 | 2.6 |
| accelerator | | | | | |
| Total sulfur | pbw | 3.20 | 2.75 | 1.76 | 6.04 |
| content | | | | | |
| Y-value of | — | 0.90 | 0.56 | 0.83 | 0.83 |
| formula (1) | | | | | |
| A-value of | — | 1.68 | 1.23 | 2.58 | 2.50 |
| formula (1) | | | | | |
| Value of the | — | 6.1 | 17.9 | 9.0 | 9.0 |
| right-hand side | | | | | |
| of formula (2) | | | | | |
| Wear | Index | 101 | 108 | 99 | 97 |
| resistance | value | | | | |
| Uneven wear | Index | 105 | 105 | 99 | 101 |
| resistance | value | | | | |
| Rolling | Index | 93 | 111 | 95 | 85 |
| resistance | value | | | | |

TABLE 2

| | | Comparative | Working | Working | Comparative | Comparative |
|---|---|---|---|---|---|---|
| | | Example 8 | Example 3 | Example 4 | Example 9 | Example 10 |
| NR | pbw | 90 | 90 | 80 | 70 | 100 |
| IR | pbw | | 10 | 20 | 30 | |
| SBR | pbw | 10 | | | | |
| Carbon black | pbw | 5 | 5 | 5 | 5 | 5 |
| 1 (Wc) | | | | | | |
| Silica (Ws) | pbw | 45 | 45 | 45 | 45 | 45 |
| Aramid pulp | pbw | | | | | |
| MB1 | | | | | | |
| Aramid pulp | pbw | | | | | |
| MB2 | | | | | | |
| Coupling | pbw | 4.5 | 4.5 | 4.5 | 4.5 | 4.5 |
| agent | | | | | | |
| Sulfur (S) | pbw | 2.3 | 2.3 | 2.3 | 2.3 | 1.0 |
| Vulcanization | pbw | 1.75 | 1.75 | 1.75 | 1.75 | 1.75 |
| accelerator | | | | | | |
| Total sulfur | pbw | 3.20 | 3.20 | 3.20 | 3.20 | 1.96 |
| content | | | | | | |
| Y-value of | — | 0.90 | 0.90 | 0.90 | 0.90 | 0.90 |
| formula (1) | | | | | | |
| A-value of | — | 1.68 | 1.68 | 1.68 | 1.68 | 2.57 |
| formula (1) | | | | | | |
| Value of the | — | 6.1 | 6.1 | 6.1 | 6.1 | 6.1 |
| right-hand | | | | | | |
| side of | | | | | | |
| formula (2) | | | | | | |
| Wear | Index | 98 | 101 | 100 | 97 | 93 |
| resistance | value | | | | | |
| Uneven wear | Index | 107 | 105 | 103 | 98 | 78 |
| resistance | value | | | | | |
| Rolling | Index | 100 | 93 | 93 | 93 | 120 |
| resistance | value | | | | | |

| | | Comparative | Working | Working | Working |
|---|---|---|---|---|---|
| | | Example 11 | Example 5 | Example 6 | Example 7 |
| NR | pbw | 100 | 100 | 100 | 100 |
| IR | pbw | | | | |
| SBR | pbw | | | | |
| Carbon black | pbw | 5 | 5 | 5 | 5 |
| 1 (Wc) | | | | | |
| Silica (Ws) | pbw | 45 | 45 | 45 | 45 |
| Aramid pulp | pbw | | 2.5 | 10 | |
| MB1 | | | | | |
| Aramid pulp | pbw | | | | 2.5 |
| MB2 | | | | | |
| Coupling | pbw | 4.5 | 4.5 | 4.5 | 4.5 |
| agent | | | | | |
| Sulfur (S) | pbw | 4.0 | 2.3 | 2.3 | 2.3 |
| Vulcanization | pbw | 1.75 | 1.75 | 1.75 | 1.75 |
| accelerator | | | | | |
| Total sulfur | pbw | 4.82 | 3.20 | 3.20 | 3.20 |
| content | | | | | |
| Y-value of | — | 0.90 | 0.90 | 0.90 | 0.90 |
| formula (1) | | | | | |
| A-value of | — | 1.66 | 1.68 | 1.68 | 1.68 |
| formula (1) | | | | | |
| Value of the | — | 6.1 | 6.1 | 6.1 | 6.1 |
| right-hand | | | | | |
| side of | | | | | |
| formula (2) | | | | | |
| Wear | Index | 83 | 101 | 100 | 100 |
| resistance | value | | | | |
| Uneven wear | Index | 105 | 107 | 110 | 107 |
| resistance | value | | | | |
| Rolling | Index | 90 | 94 | 92 | 89 |
| resistance | value | | | | |

The types of raw materials used as per Tables 1 and 2 are described below.

NR: natural rubber, STR 20

IR: isoprene rubber, Nipol IR2200 manufactured by the Zeon Corporation

SBR: styrene-butadiene rubber, Nipol 1502 manufactured by the Zeon Corporation, non-oil-extended product

Carbon black 1: ISAF-grade carbon black, Show Black N234 manufactured by Cabot Japan K.K.

Silica: 1165MP, manufactured by Degussa

Coupling agent: sulfur-containing silane coupling agent (sulfur content: 22.5 wt. %), Si69, manufactured by Degussa

Aramid pulp MB1: master batch containing 40 wt. % of aramid pulp, Twaron D3500 manufactured by Teijin, Ltd.

Aramid pulp MB2: master batch containing 40 wt. % of aramid pulp, Sulflon D3515 manufactured by Teijin, Ltd.

Sulfur: Golden Flower oil treated sulfur powder (sulfur content: 95 wt. %), manufactured by Tsurumi Chemical Industry Co., Ltd.

Vulcanization accelerator: sulfenamide vulcanization accelerator, SANTOCURE CBS manufactured by FLEXSYS

TABLE 3
Composition of shared formulation

| | |
|---|---|
| Zinc oxide | 3.0 pbw |
| Stearic acid | 1.5 pbw |
| Antiaging agent | 1.5 pbw |

The types of raw materials used as per Table 3 are described below.

Zinc oxide: type III Zinc Oxide, manufactured by Seido Chemical Industry Co., Ltd.

Stearic acid: beads stearic acid, manufactured by NOF Corporation

Antiaging agent: Antigen 6C, manufactured by Sumitomo Chemical Co., Ltd.

As is clear from Tables 1 and 2, it was confirmed that heavy-load pneumatic tires formed using the rubber compositions for a heavy-load pneumatic tire of Working Examples 1 to 7 exhibited a balance of wear resistance, uneven wear resistance, and low rolling resistance that was enhanced to or beyond conventional levels.

In addition, as is clear from Table 1, the compounded amount of sulfur in the rubber composition of Comparative Example 2 is less than 1.5 parts by weight, so the crosslinking density is reduced, and the wear resistance, uneven wear resistance, and low rolling resistance are respectively diminished.

The compounded amount of sulfur in the rubber composition of Comparative Example 3 exceeds 3.5 parts by weight, and the amount of the vulcanization accelerator is small, so the crosslinking density is reduced, and the wear resistance, uneven wear resistance, and low rolling resistance are respectively diminished. The compounded amount of silica in the rubber composition of Comparative Example 4 exceeds 50 parts by weight, and the composition does not contain carbon black, so the wear resistance is diminished. The compounded amount of silica in the rubber composition of Comparative Example 5 is less than 30 parts by weight, so the rolling resistance is diminished. The total of the sulfur and the sulfur in the sulfur-containing silane coupling agent of the rubber composition of Comparative Example 6 is less than 1.85 parts by weight, so it is not possible to enhance the uneven wear resistance. The total of the sulfur and the sulfur in the sulfur-containing silane coupling agent of the rubber composition of Comparative Example 7 exceeds 6.0 parts by weight, so the wear resistance is diminished.

As is clear from Table 2, the rubber composition of Comparative Example 8 contains 10 parts by weight of SBR in the diene rubber, so the wear resistance is diminished, and the rolling resistance cannot be enhanced. The compounded amount of the natural rubber in the rubber composition of Comparative Example 9 is less than 80 parts by weight, and the compounded amount of the isoprene rubber exceeds 20 parts by weight, so the wear resistance and uneven wear resistance are diminished. The compounded amount of sulfur in the rubber composition of Comparative Example 10 is less than 1.5 parts by weight, so the wear resistance, uneven wear resistance, and low rolling resistance are respectively diminished. The compounded amount of sulfur in the rubber composition of Comparative Example 11 exceeds 3.5 parts by weight, so the wear resistance is diminished.

Next, three types of heavy-load pneumatic tires in which the rubber compositions forming the tread cap portions and undertread portions were varied as described in Table 4 (tires 1 and 2 of the present technology and comparative tire 1) were vulcanization molded. In addition, the formulation of the rubber compositions forming the undertread portions was as described in Table 5, and the compositions were prepared by kneading the components excluding sulfur and the vulcanization accelerator in a 1.8 L sealed mixer for 5 minutes at 160° C., extruding the mixture as a master batch, adding sulfur and the vulcanization accelerator to the master batch, and then kneading the master batch with an open roller.

The obtained heavy-load pneumatic tires (tires 1 and 2 of the present technology and comparative tire 1) were used to test for wear resistance, uneven wear resistance, rolling resistance, and durability. The test methods for the wear resistance, uneven wear resistance, and rolling resistance are as described above, and the obtained results are shown in Table 4 as an index with the value of comparative tire 1 being defined as 100. In addition, durability tests of the heavy-load pneumatic tires were performed with the following method.

### Durability

Pneumatic tire having a tire size of 275/80R22.5 were vulcanization molded, and the obtained tires were assembled on a standard rim (wheel with a size of 22.5×8.25). The assemblies were then mounted on an indoor drum testing machine (drum diameter: 1,707 mm) in accordance with JIS D4230, and a traveling test was started at a speed of 45 km/hr with a slip angle of 2 degrees under air pressure of 900 kPa, using an initial load of 33.8 kN. After starting the test, the load was increased by 10% of the initial load every 24 hours, and the traveling test was continued until the tire was broken. The traveling distance until the tire breakage was measured. The obtained results are shown in the “Durability” row of Table 4 as an index with the value of comparative tire 1 being defined as 100. Larger index values indicate superior tire durability.

TABLE 4

| | | Present | Present |
|---|---|---|---|
| | Comparative | Technology | Technology |
| | Tire 1 | Tire 1 | Tire 2 |
| Rubber composition of the | Comparative | Working | Working |
| tread cap portion | Example 1 | Example 2 | Example 2 |
| Rubber composition of the | Reference | Reference | Reference |
| undertread portion | Example 1 | Example 1 | Example 2 |
| Wear resistance | 100 | 101 | 103 |
| Uneven wear resistance | 100 | 107 | 107 |
| Rolling resistance | 100 | 94 | 89 |
| Durability | 100 | 106 | 130 |

TABLE 5

| | | Reference | Reference |
|---|---|---|---|
| | | Example 1 | Example 2 |
| NR | pbw | 85 | 85 |
| BR | pbw | 15 | 15 |
| Carbon black 2 | pbw | 32 | |
| Carbon black 3 | pbw | | 32 |
| Silica | pbw | 13 | 13 |
| Coupling agent | pbw | 1.3 | 1.3 |
| Zinc oxide | pbw | 3.0 | 3.0 |
| Stearic acid | pbw | 1.5 | 1.5 |
| Antiaging agent | pbw | 1.5 | 1.5 |
| Sulfur | pbw | 2.0 | 2.0 |
| Vulcanization accelerator | pbw | 1.5 | 1.5 |

The types of raw materials used as per Table 5 are described below.

NR: natural rubber, STR 20

BR: Butadiene rubber; Nipol BR1220, manufactured by Zeon Corporation

Carbon black 2: Niteron #300IH manufactured by NSCC Carbon Co., Ltd., N₂SA=120 m²/g, DBP absorption number=126 ml/100 g

Carbon black 3: SEAST 116HM manufactured by Tokai Carbon Co., Ltd.; N₂SA=56 m²/g, DBP absorption number=158 mL/100 g

Silica: Nipsil AQ manufactured by Tosoh Silica Corporation

Coupling agent: silane coupling agent, Si69 manufactured by Evonik Degussa

Zinc oxide: type III Zinc Oxide, manufactured by Seido Chemical Industry Co., Ltd.

Stearic acid: beads stearic acid, manufactured by NOF Corporation

Antioxidant: Santoflex 6PPD, manufactured by Flexsys

Sulfur: Golden Flower oil treated sulfur powder, manufactured by Tsurumi Chemical Industry Co., Ltd.

Vulcanization accelerator: Nocceler NS-P, manufactured by Ouchi Shinko Chemical Industrial Co., Ltd.

It was confirmed from the results of Table 4 that tires 1 and 2 of the present technology exhibited wear resistance, uneven wear resistance, rolling resistance, and durability superior to those of comparative tire 1.

Eight types of rubber compositions for a heavy-load pneumatic tire for construction vehicles containing the compounding agents described in Table 7 as a shared formulation and the formulations described in Table 6 (Working Examples 8 to 10 and Comparative Examples 12 to 16) were prepared by kneading the components excluding sulfur and the vulcanization accelerator in a 1.8 L sealed mixer for 5 minutes at 160° C., extruding the mixture as a master batch, adding the sulfur and the vulcanization accelerator to the master batch, and then kneading the master batch with an open roller. The total amount of sulfur in the sulfur and the sulfur-containing silane coupling agent is described in the “total sulfur content” row of Table 6. The added amounts of the shared compounding agents described in Table 7 are expressed as parts by weight per 100 parts by weight of the diene rubbers (100 parts by weight of the net amount of rubber) described in Table 6.

Test pieces were produced by vulcanizing the obtained eight types of rubber compositions in molds with a prescribed shape at 150° C. for 30 minutes, and the heat build-up (tan δ at 60° C.) was evaluated using the dynamic visco-elasticity as an index in accordance with the method described below.

### Heat Build-Up (Tan δ at 60° C.)

Using a viscoelastic spectrometer, manufactured by Toyo Seiki Seisaku-sho, Ltd., the loss tangent, tan δ, at a temperature of 60° C. of the obtained test piece was measured in accordance with JIS K6394 under conditions at an initial strain of 10%, an amplitude of ±2%, and a frequency of 20 Hz. The resulting tan δ values are described in the “Heat build-up” row of Table 6 as an index with the value of Comparative Example 12 being defined as 100. Smaller index values indicate smaller heat build-up, which suppresses increases in the tire temperature due to heat build-up when the tire is traveling and makes it possible to enhance the tire durability. In addition, this simultaneously means that the rolling resistance is small when the composition is used to produce a pneumatic tire.

The obtained eight types of rubber compositions for a heavy-load pneumatic tire were used in tread cap portions, heavy-load pneumatic tires were vulcanization molded, and the obtained heavy-load pneumatic tires were used to test for the wear resistance and uneven wear resistance with the following methods.

### Wear Resistance

Pneumatic tires with a tire size of 2700R49 were vulcanization molded, and the resulting tires were assembled on a standard rim (rim with a size of 49×19.50−4.0), filled with 700 kPa of air pressure, and mounted on the same type of construction vehicle. This construction vehicle was repeatedly made to travel over a certain interval of a mine, and when the construction vehicle had traveled the same distance for each tire, the groove depth (remaining groove) of each main groove was measured. The obtained results are shown in the “Wear resistance” row as an index with the value of Comparative Example 12 being defined as 100. Larger index values of wear resistance indicate better wear resistance and better tire durability.

### Uneven Wear Resistance

Pneumatic tires with a tire size of 2700R49 were vulcanization molded, and the resulting tires were assembled on a standard rim (rim with a size of 49×19.50−4.0), filled with 700 kPa of air pressure, and mounted on the same type of construction vehicle. The vehicle was made to travel through the mine for 3,000 hours in a state in which a load of 27,250 kg was applied to each tire. The inflation profile prior to this traveling test and the inflation profile after this traveling test were compared, and the value of “(amount of wear of shoulder edge)−(amount of wear of outer main groove)” was measured and used as the amount of shoulder drop wear (amount of uneven wear). The obtained results are shown in the “Uneven wear resistance” row as an index with the inverse of the value of Comparative Example 12 being defined as 100. Larger index values of uneven wear resistance indicate better uneven wear resistance and better tire durability.

TABLE 6

| | | Comparative | Comparative | Comparative | Comparative | Comparative |
|---|---|---|---|---|---|---|
| | | Example 12 | Example 13 | Example 14 | Example 15 | Example 16 |
| NR | pbw | 100 | 100 | 100 | 100 | 100 |
| Carbon black | pbw | 13 | 25 | 15 | 0 | 5 |
| 1 (Wc) | | | | | | |
| Silica (Ws) | pbw | 37 | 25 | 25 | 55 | 45 |
| Coupling | pbw | 3.7 | 2.5 | 2.5 | 5.5 | 4.5 |
| agent | | | | | | |
| Sulfur (S) | pbw | 2.7 | 2.95 | 2.95 | 2.25 | 4 |
| Vulcanization | pbw | 1.70 | 1.70 | 1.70 | 1.70 | 1.70 |
| accelerator | | | | | | |
| Total sulfur | pbw | 3.53 | 3.51 | 3.51 | 3.49 | 5.01 |
| content | | | | | | |
| Y-value of | — | 0.74 | 0.50 | 0.63 | 1.00 | 0.90 |
| formula (1) | | | | | | |
| A-value of | — | 1.35 | 1.00 | 1.16 | 1.84 | 1.66 |
| formula (1) | | | | | | |
| Value of the | — | 10.8 | 17.9 | 17.9 | 0.2 | 6.1 |
| right-hand | | | | | | |
| side of | | | | | | |
| formula (2) | | | | | | |
| Wear | Index | 100 | 90 | 106 | 92 | 93 |
| resistance | value | | | | | |
| Uneven wear | Index | 100 | 91 | 102 | 93 | 105 |
| resistance | value | | | | | |
| Heat build-up | Index | 100 | 106 | 107 | 80 | 87 |
| (tanδ 60° C.) | value | | | | | |

| | | Working | Working | Working |
|---|---|---|---|---|
| | | Example 8 | Example 9 | Example 10 |
| NR | pbw | 100 | 100 | 100 |
| Carbon black | pbw | 5 | 10 | 10 |
| 1 (Wc) | | | | |
| Silica (Ws) | pbw | 45 | 45 | 37 |
| Coupling | pbw | 4.5 | 4.5 | 3.7 |
| agent | | | | |
| Sulfur (S) | pbw | 2.5 | 2.5 | 2.7 |
| Vulcanization | pbw | 1.70 | 1.7 | 1.7 |
| accelerator | | | | |
| Total sulfur | pbw | 3.51 | 3.51 | 3.53 |
| content | | | | |
| Y-value of | — | 0.90 | 0.82 | 0.79 |
| formula (1) | | | | |
| A-value of | — | 1.62 | 1.51 | 1.42 |
| formula (1) | | | | |
| Value of the | — | 6.1 | 6.1 | 10.8 |
| right-hand | | | | |
| side of | | | | |
| formula (2) | | | | |
| Wear | Index | 100 | 103 | 100 |
| resistance | value | | | |
| Uneven wear | Index | 100 | 102 | 100 |
| resistance | value | | | |
| Heat build-up | Index | 90 | 93 | 87 |
| (tanδ 60° C.) | value | | | |

The types of raw materials used as per Table 6 are described below.

NR: natural rubber, STR 20

Carbon black 1: ISAF-grade carbon black, Show Black N234 manufactured by Cabot Japan K.K.

Silica: 1165MP, manufactured by Degussa

Coupling agent: sulfur-containing silane coupling agent (sulfur content: 22.5 wt. %), Si69, manufactured by Degussa

Sulfur: Golden Flower oil treated sulfur powder (sulfur content: 95 wt. %), manufactured by Tsurumi Chemical Industry Co., Ltd.

Vulcanization accelerator: sulfenamide vulcanization accelerator, SANTOCURE CBS manufactured by FLEXSYS

TABLE 7
Composition of shared formulation

| | |
|---|---|
| Zinc oxide | 4.0 pbw |
| Stearic acid | 2.0 pbw |
| Antiaging agent | 2.0 pbw |

The types of raw materials used as per Table 7 are described below.

Zinc oxide: type III Zinc Oxide, manufactured by Seido Chemical Industry Co., Ltd.

Stearic acid: beads stearic acid, manufactured by NOF Corporation

Antiaging agent: Antigen 6C, manufactured by Sumitomo Chemical Co., Ltd.

As is clear from Table 6, it was confirmed that heavy-load pneumatic tires formed using the rubber compositions for a heavy-load pneumatic tire of Working Examples 8 to 10 exhibited a balance of wear resistance, uneven wear resistance, and low rolling resistance that was enhanced to or beyond conventional levels.

In addition, as is clear from Table 6, the compounded amount of silica in the rubber composition of Comparative Example 13 is less than 35 parts by weight, which does not satisfy the relationship between the compounded amount of carbon black and the compounded amount of silica described in formula (2), so the rolling resistance, wear resistance, and uneven wear resistance are diminished. The amount of silica in the rubber composition of Comparative Example 14 is less than 35 parts by weight, so the rolling resistance is diminished. The compounded amount of silica in the rubber composition of Comparative Example 15 exceeds 50 parts by weight, so the wear resistance and uneven wear resistance are diminished. The compounded amount of sulfur in the rubber composition of Comparative Example 16 exceeds 3.5 parts by weight, so the wear resistance is diminished.

1. A rubber composition for a heavy-load pneumatic tire, the rubber composition comprising: from 35 to 50 parts by weight of silica, from 1.5 to 3.5 parts by weight of sulfur, carbon black, a sulfenamide vulcanization accelerator, and a sulfur-containing silane coupling agent per 100 parts by weight of a diene rubber containing from 80 to 100 wt. % of a natural rubber and from 20 to 0 wt. % of an isoprene rubber; a total amount of the sulfur and the sulfur in the sulfur-containing silane coupling agent being from 1.85 to 6.0 parts by weight; and a compounded amount of the sulfenamide vulcanization accelerator being from A parts by weight to 2.6 parts by weight both inclusive, where A is determined by the following formula (1):
A=0.2209S²−1.409S+1.309Y+2.579 (1)
where in formula (1), A is a lower limit of the compounded amount (parts by weight) of the sulfenamide vulcanization accelerator, S is the compounded amount (parts by weight) of the sulfur, and Y is a positive number determined by Y=Ws/(Ws+Wc), where Ws is a compounded amount (parts by weight) of the silica, and Wc is a compounded amount (parts by weight) of the carbon black.

2. The rubber composition for a heavy-load pneumatic tire according to claim 1, wherein the carbon black is ISAF grade or SAF grade, and the compounded amount Wc of the carbon black and the compounded amount Ws of the silica satisfy the relation of the following formula (2):
Wc≦32.71−0.592Ws (2)
where in formula (2), Ws is the compounded amount (parts by weight) of the silica, and Wc is the compounded amount (parts by weight) of the carbon black.

3. A heavy-load pneumatic tire comprising a tread cap formed from the rubber composition for a heavy-load pneumatic tire described in claim 1.

4. The heavy-load pneumatic tire according to claim 3, wherein an undertread is formed from a rubber composition for an undertread containing from 15 to 45 parts by weight of carbon black and from 3 to 30 parts by weight of silica per 100 parts by weight of a diene rubber comprising from 70 to 90 wt. % of a natural rubber and/or an isoprene rubber and from 30 to 10 wt. % of a butadiene rubber and/or a styrene-butadiene rubber, and containing a silane coupling agent in an amount of from 5 to 15 wt. % of the amount of the silica, and a nitrogen adsorption specific surface area N₂SA of the carbon black is from 35 to 85 m²/g, and a DBP absorption number is from 110 to 200 ml/100 g.

5. A heavy-load pneumatic tire comprising a tread cap formed from the rubber composition for a heavy-load pneumatic tire described in claim 2.

6. The heavy-load pneumatic tire according to claim 5, wherein an undertread is formed from a rubber composition for an undertread containing from 15 to 45 parts by weight of carbon black and from 3 to 30 parts by weight of silica per 100 parts by weight of a diene rubber comprising from 70 to 90 wt. % of a natural rubber and/or an isoprene rubber and from 30 to 10 wt. % of a butadiene rubber and/or a styrene-butadiene rubber, and containing a silane coupling agent in an amount of from 5 to 15 wt. % of the amount of the silica, and a nitrogen adsorption specific surface area N₂SA of the carbon black is from 35 to 85 m²/g, and a DBP absorption number is from 110 to 200 ml/100 g.
